(19) United States
(12) Patent Application Publication
(10) Pub. No.: US 2016/0065444 A1
(43) Pub. Date: Mar. 3, 2016

(54) ANOMALY DETECTION BASED ON COMBINATIONS OF CAUSE VALUE, MESSAGE TYPE, RESPONSE TIME (GTP-C)

(71) Applicant: Arbor Networks, Inc., Burlington, MA (US)

(72) Inventors: Mark Schunder, South Lyon, MI (US); R. G. Reed, Canton, MI (US); Joseph Welch, Ypsilanti, MI (US); Carl Anderson, Brighton, MI (US); Joanna Markel, Ann Arbor, MI (US)

(73) Assignee: Arbor Networks, Inc., Burlington, MA (US)

(21) Appl. No.: 14/469,275

(22) Filed: Aug. 26, 2014

(51) Int. Cl. H04L 12/26; H04W 24/10

(52) U.S. Cl. CPC H04L 43/16; H04W 24/10

(57) ABSTRACT

A method for monitoring control traffic in a network is provided. A network monitoring probe passively monitors one or more network performance metrics related to control traffic. A plurality of threshold values associated with the one or more network performance metrics is received from a user. An alert notification message is sent to the user via an alert engine, in response to determining that at least one of the plurality of threshold values has been reached by the control traffic.

### FIELD OF THE INVENTION

Embodiments of the present invention relate to a method for monitoring a GTP communication path in a UMTS/GPRS/LTE network and, more particularly, to anomaly detection based on combinations of cause value, message type and response time.

### BACKGROUND OF THE INVENTION

The GPRS (General Packet Radio Service) Tunneling Protocol, abbreviated GTP, is an IP-based protocol that is used within GSM, UMTS and LTE networks. The GTP tunnels so-called GPRS packet data units by means of the GPRS backbone network, and overrides the User Datagram Protocol, abbreviated UDP. GTP fundamentally comprises three separate protocols, GTP-C, GTP-U, and GTP′. GTP-C (control traffic) is used within the GPRS backbone (core) network for signaling purposes between GPRS network nodes, for example, SGSN (Serving GPRS Support Node) and GGSN (Gateway GPRS Support Node). GTP-U (user traffic) is used as a carrier for user data within the GPRS network and between the wireless access network and the core networks. GTP′ is used as a carrier for billing data in the GPRS network, among other things.

The monitoring functions in the network are maintained by means of GTP-C monitoring messages that are exchanged between the network nodes. The status of the communication paths between the network nodes can also be monitored and checked by means of GTP-C messages. For this purpose, a network node transmits a so-called GTP echo request message to another network node, which acknowledges this message with a GTP echo response message. The GTP echo function in the GTP is comparable with the PING function according to the ICMP (Internet Control Message Protocol) protocol. GTP echo is a PING within the GTP protocol.

### SUMMARY OF THE INVENTION

The purpose and advantages of the illustrated embodiments will be set forth in and apparent from the description that follows. Additional advantages of the illustrated embodiments will be realized and attained by the devices, systems and methods particularly pointed out in the written description and claims hereof, as well as from the appended drawings.

In accordance with a purpose of the illustrated embodiments, in one aspect, a method for monitoring control traffic in a network is provided. A network monitoring probe monitors one or more network performance metrics related to control traffic. A plurality of threshold values associated with the one or more network performance metrics is received from a user. An alert notification message is sent to the user via an alert engine, in response to determining that at least one of the plurality of threshold values has been reached by the control traffic.

In another aspect, a computer program product for monitoring control traffic in a network is provided. The computer program product comprises one or more computer-readable storage devices and a plurality of program instructions stored on at least one of the one or more computer-readable storage devices. The plurality of program instructions includes program instructions to monitor one or more network performance metrics related to control traffic. The plurality of program instructions further includes program instructions to receive from a user a plurality of threshold values associated with the one or more network performance metrics. The plurality of program instructions further includes program instructions to send an alert notification message to the user, in response to determining that at least one of the plurality of threshold values has been reached by the control traffic.

### BRIEF DESCRIPTION OF THE DRAWINGS

The accompanying appendices and/or drawings illustrate various, non-limiting, examples, inventive aspects in accordance with the present disclosure:

FIG. 1 schematically shows an embodiment of a system for monitoring a GTP communication path in a UMTS/GPRS/LTE network in accordance with an embodiment of the invention;

FIG. 2 is a flowchart of operational steps of the monitoring system of FIG. 1, in accordance with an illustrative embodiment of the present invention;

FIGS. 3A-3C are schematic diagrams illustrating user interface screenshots of a monitoring system for generating network-wide and node-specific GTP-C alert configuration data in accordance with an embodiment of the present invention;

FIG. 4 is an exemplary alert screen for presenting alert information according to an embodiment of the present invention;

FIGS. 5A-5C are schematic diagrams illustrating modified user interface screenshots of FIGS. 3A-3C utilizing sparklines and line graphs in accordance with an alternative embodiment of the present invention; and

FIG. 6 is a block diagram illustrating a typical monitoring server that may be employed to implement processing functionality described herein, according to some embodiments.

### DETAILED DESCRIPTION OF CERTAIN EMBODIMENTS

The present invention is now described more fully with reference to the accompanying drawings, in which illustrated embodiments of the present invention are shown wherein like reference numerals identify like elements. The present invention is not limited in any way to the illustrated embodiments as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described below. One skilled in the art will appreciate further features and advantages of the invention based on the below-described embodiments. Accordingly, the invention is not to be limited by what has been particularly shown and described, except as indicated by the appended claims.

In exemplary embodiments, a computer system component may constitute a “module” that is configured and operates to perform certain operations as described herein below. Accordingly, the term “module” should be understood to encompass a tangible entity, be that an entity that is physically constructed, permanently configured (e.g., hardwired) or temporarily configured (e.g. programmed) to operate in a certain manner and to perform certain operations described herein.

The increasing reliance upon computer systems to collect, process, and analyze data makes computer network security and performance ever more important. One aspect of network security relates to what is referred to herein as “deliberate malicious traffic”—a set of computer instructions that perform a function unauthorized by the user. Malicious traffic typically appears in various forms, including viruses, worms, and Trojan horses. Aberrant and/or malicious traffic typically exploits vulnerabilities in a network to self-propagate through the network to infect machines, or “nodes”, connected to the network, causing damage generated by the data payload and increasing the consumption of network bandwidth to the detriment of the performance of the network and infected network nodes in performing legitimate operations. Malicious traffic propagates most efficiently by attacking commonly used services on common network hosts. This means that, by definition, malicious traffic is traveling over the very services that most commonly appear on the network.

Malicious traffic can adversely affect the experience of the network's users. These adverse effects include slow connections, intermittent connectivity, complete loss of connectivity, data theft, spoofed or malicious data.

Since data traffic transmitted over networks is steadily growing, traffic monitoring is becoming increasingly important for network suppliers and network operators in order to determine the so-called quality of service (QoS) within the network. One way for determining the QoS in a network is to perform passive measurements (monitoring) within the network. Passive measurement means that network traffic is captured at certain interfaces within the network. Performance indicators indicative of the QoS are obtained by processing the captured network traffic. In case of passive measurements, end-user perceived quality may be approximated by means of the performance indicators. Understanding the amount and type of GTP-C traffic that is passing through an individual network node (SGSN or GGSN, for example) is essential to pinpointing and diagnosing problems within a mobile network.

In one aspect, various embodiments of the present invention utilize GTP-C protocol to monitor control plane traffic across an entire mobile network deployment to enable mobile network operators to understand the amount and type of mobile traffic that is passing through their mobile network. When an SGSN breaks down, it may not be possible to terminate the session in a controlled way. The detection of an SGSN failure in this case may be achieved through the “Echo request/response mechanism” in the GGSN. This mechanism is advantageously applied on the GTP-C paths. The “Echo request/response mechanism” can also be used during a controlled termination. Described embodiments of the present invention are directed to utilizing this request/response mechanism as well as a plurality of network performance metrics related to control traffic to detect anomalies within the control traffic.

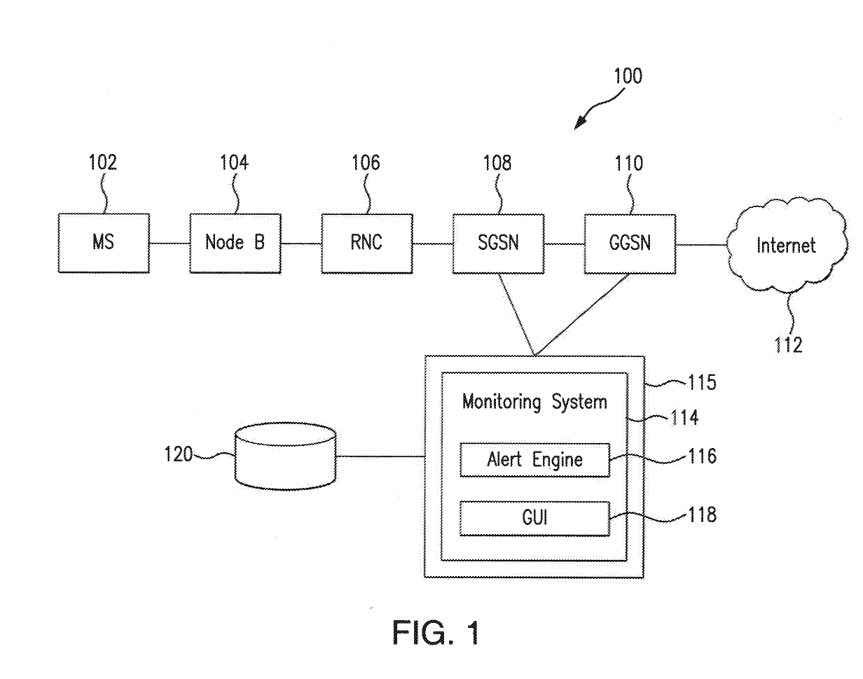

Referring to FIG. 1 of the drawings, FIG. 1 is a high level diagram of an example UMTS/GPRS/LTE network 100, in which an embodiment of the present invention may be implemented. The network 100 comprises mobile station (MS) 102, which can be a mobile wireless device, such as a cell phone or smart phone, a laptop, notebook, tablet computer, palm-sized computer, or any electronic device with capability to receive communication (i.e. wireless) signals. Mobile station 102 is connected with one or more base stations, known as Node B 104. In other words, Node Bs 104 collectively provide for the geographic coverage for wireless communications between mobile station 102 and the rest of the network 100. Groups of one or more Node Bs 104 are connected to a Radio Network Controller (RNC) 106. In other words, Node B 104 is controlled by RNC 106, preferably a wireless network controller, which coordinates the operation of a plurality of node Bs 104. RNC 106 is connected with serving GPRS support node (SGSN) 108. SGSN 108 is a network node that functions as a telephone switch and switches the data traffic from and to RNC 106 and other points of network 100. SGSN 108 is connected with gateway GPRS support node (GGSN) 110, which represents the GPRS gateway network node. GGSN 110 functions as a gateway to other data networks, for example, the Internet 112. Of course, a UMTS/GPRS/LTE network 100 may include a plurality of MS 102, Node B 104, RNC 106, SGSN 108, GGSN 110 elements or systems, with only one such network element being represented in FIG. 1 as an example.

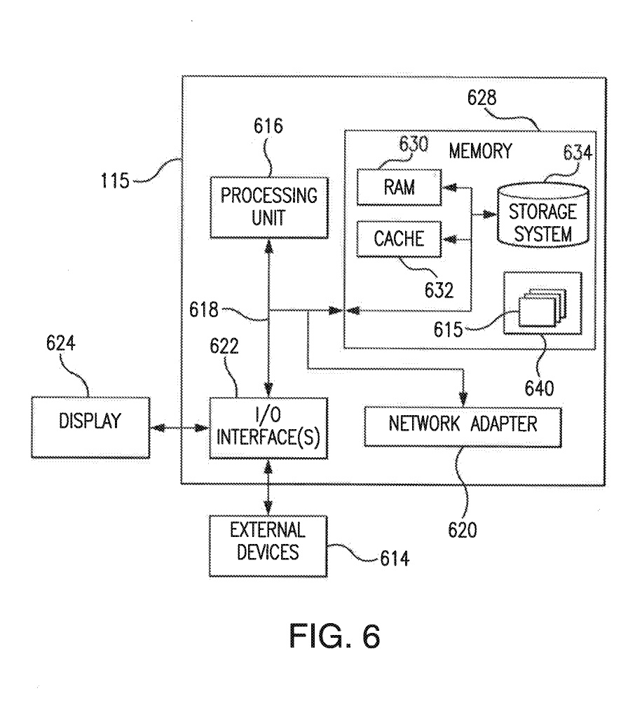

According to embodiments of the present invention, a monitoring system 114 may be connected with one or more network nodes, for example, SGSN 108 and GGSN 110. The monitoring system 114 includes a computer having a processor and memory for storing instructions (shown in FIG. 6). The memory can be any type of memory or other computer readable media that stores instructions that are executed by the processor. A computer readable storage medium may be, for example, but not limited to, an electronic, magnetic, optical, electromagnetic, infrared, or semiconductor system, apparatus, or device, or any suitable combination of the foregoing. Generally speaking, monitoring system 114 can be any type of computer or other computing device containing computer executable program instructions to allow data communication with other elements of the UMTS/GPRS/LTE network 100 and containing computer executable program instructions to carry out the method described herein.

As previously indicated, monitoring system 114 monitors network 100. Monitoring system 114 may query, receive data from, store configuration information and other data for and send communication to network 100. Monitoring system 114 may comprise a plurality of network devices/probes operable to monitor other network nodes in network 100. For example, monitoring system 114 may comprise a plurality of monitoring computers. In the illustrated embodiment, monitoring system 114 runs on monitoring computer 115. Monitoring computer 115 may be adapted to execute any operating system including UNIX, Windows or any other suitable operating system. In alternative embodiments, monitoring system 114 can also be part of SGSN 108 or another network node.

In one embodiment, monitoring system 114 includes a graphical user interface (GUI) 118 and an alert engine 116. GUI 118 comprises a graphical user interface operable to allow the user of monitoring computer 115 to monitor network 100. Generally, GUI 118 provides the user of monitoring computer 115 with an efficient user-friendly presentation of data provided by monitoring computer 115 or network 100. GUI 118 may comprise a plurality of displays having interactive fields, pull-down lists, and buttons operated by the user. In one example, GUI 118 presents an interface and receives commands from the user. It should be understood that the term graphical user interface may be used in the singular or the plural to describe one or more graphical user interfaces in each of the displays of a particular graphical user interface. Furthermore, GUI 118 contemplates any graphical user interface that efficiently presents the network performance related information to the user.

Monitoring system 114 further includes an alert engine 116 that monitors some or all of the GTP-C (control traffic) data generated by network nodes in real-time to check for user defined alert conditions. In various embodiments, alert engine 116 can be configured to notify a network operator/administrator of alert conditions by an appropriate communications method. In one embodiment, alert engine 116 compares network-wide control traffic information and/or control traffic information associated with a selected node to an associated threshold value. In response to the associated control traffic information violating the threshold value, alert engine 116 may automatically communicate an alert communication message to the user of computer 115, for example, via GUI 118. The term “automatically,” as used herein, generally means that the appropriate processing is substantially performed by monitoring computer 115. For example, alert engine 116 can be configured to notify a system administrator whenever the average response time of one or more network transactions exceeds a certain threshold, or when one of the nodes (such as SGSN 108) becomes inaccessible within the network 100. Control traffic data gathered, generated, and maintained for use by alert engine 116 may be kept in the internal storage of monitoring computer 115 or in one or more databases of a storage unit 120. In various embodiments, storage unit 120 may store alert configuration data described below.

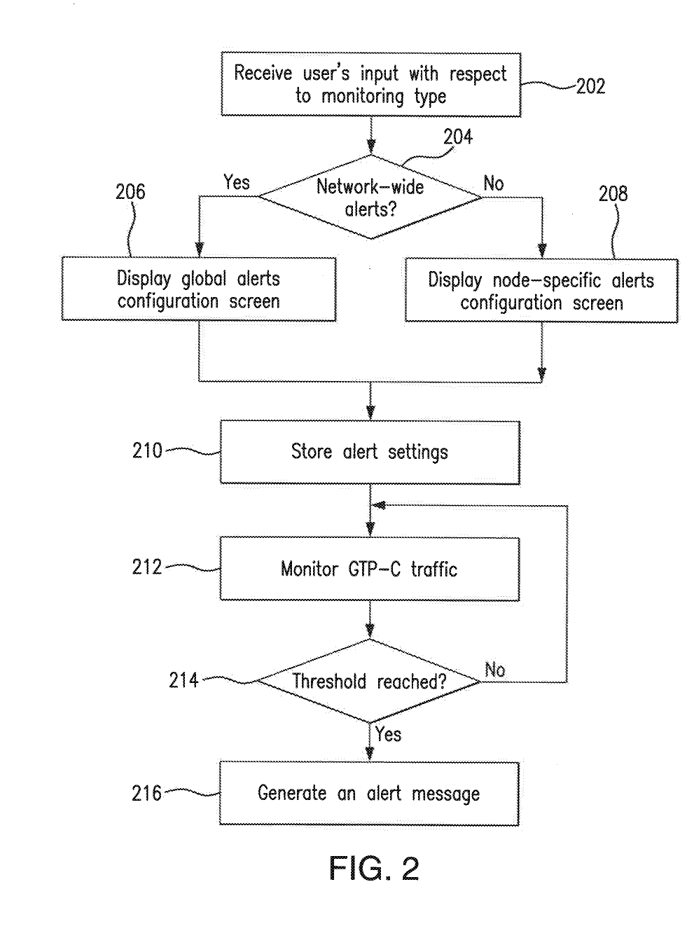

FIG. 2 is a flowchart of operational steps of the monitoring system 114 of FIG. 1, in accordance with exemplary embodiments of the present invention. Before turning to description of FIG. 2, it is noted that the flow diagram in FIG. 2 shows example in which operational steps are carried out in a particular order, as indicated by the lines connecting the blocks, but the various steps shown in this diagram can be performed in any order, or in any combination or sub-combination. It should be appreciated that in some embodiments some of the steps described below may be combined into a single step. In some embodiments, one or more additional steps may be included.

It is contemplated that certain embodiments of monitoring system 114 described herein are capable to continually monitor GTP-C traffic data over a wide range of operating conditions, such as, for example, an overall GTP-C message volume experienced across the entire network 100 and/or GTP-C message volume experienced at any particular node within network 100. Monitoring system 114 can also analyze the monitored data in real-time and provide an assessment of the performance of a particular node or an entire network 100. In other words, at a network level, the user may monitor the performance of individual node elements and link elements of the communications network 100 by inspection of the control traffic of selected elements in order to gain an appreciation of the performance of the network as a whole, or of specific node or link elements of network 100. By monitoring the control traffic of each network element of interest in relation to a selected network performance metric or service parameter, selected via GUI 118, the user may identify problems or inefficiencies in network 100. For example, a user may identify a particular link where the volume of control traffic presented to the link exceeds the bandwidth of the link, leading to loss of control plane signals over the network 100 and poor quality of QoS between users of the network 100. In one embodiment, at 202, monitoring system 114 preferably receives user's input specifying a desirable monitoring type (i.e., monitoring entire network, monitoring specific node and the like).

At 204, monitoring system 114, based on the user input received at 202, preferably determines whether the user is interested in setting one or more global alerts by configuring one or more global network performance metrics related to control traffic.

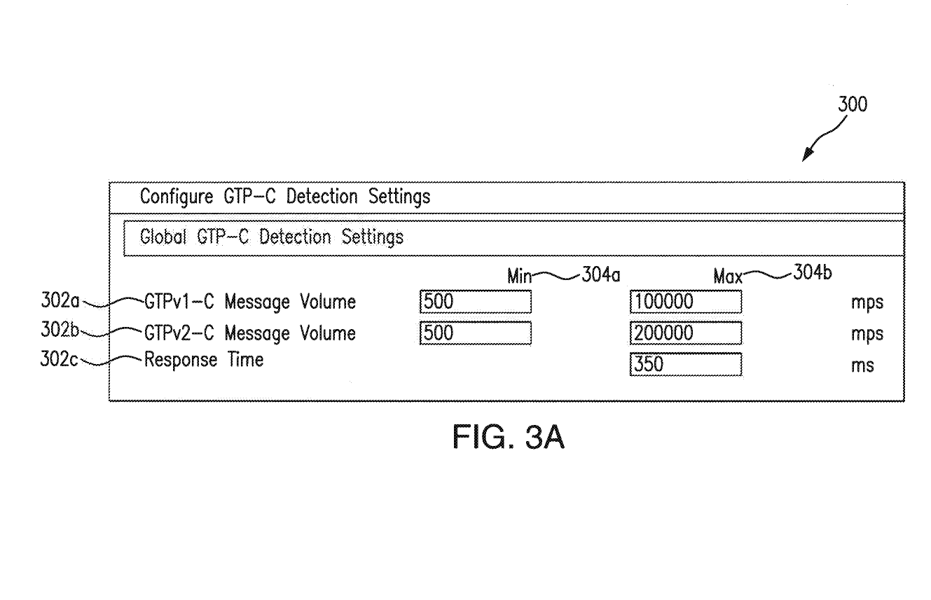

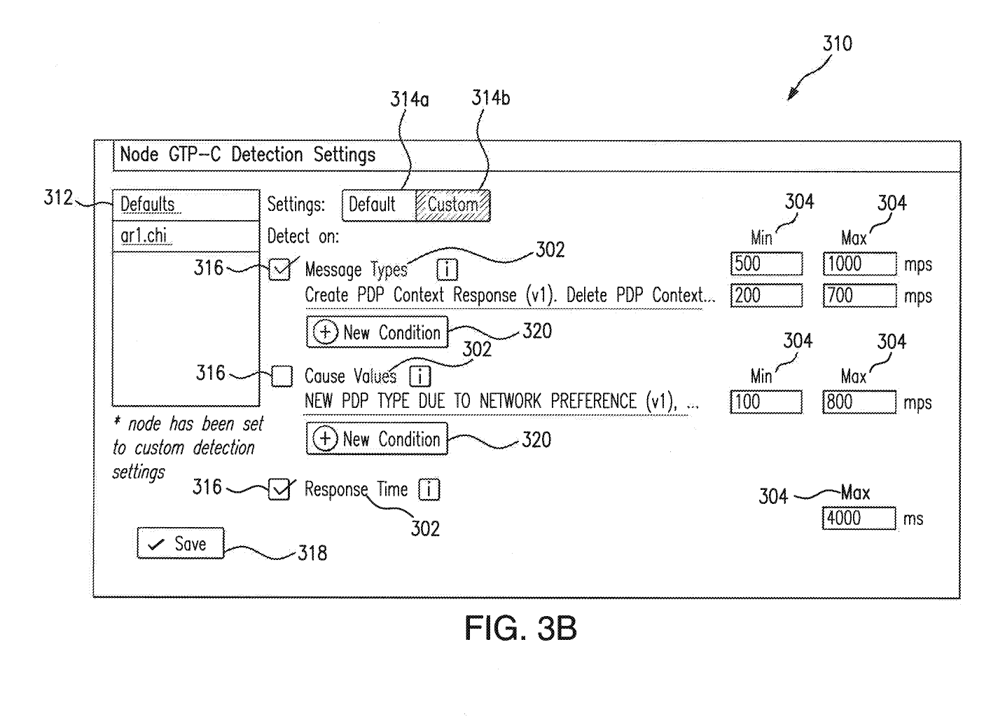

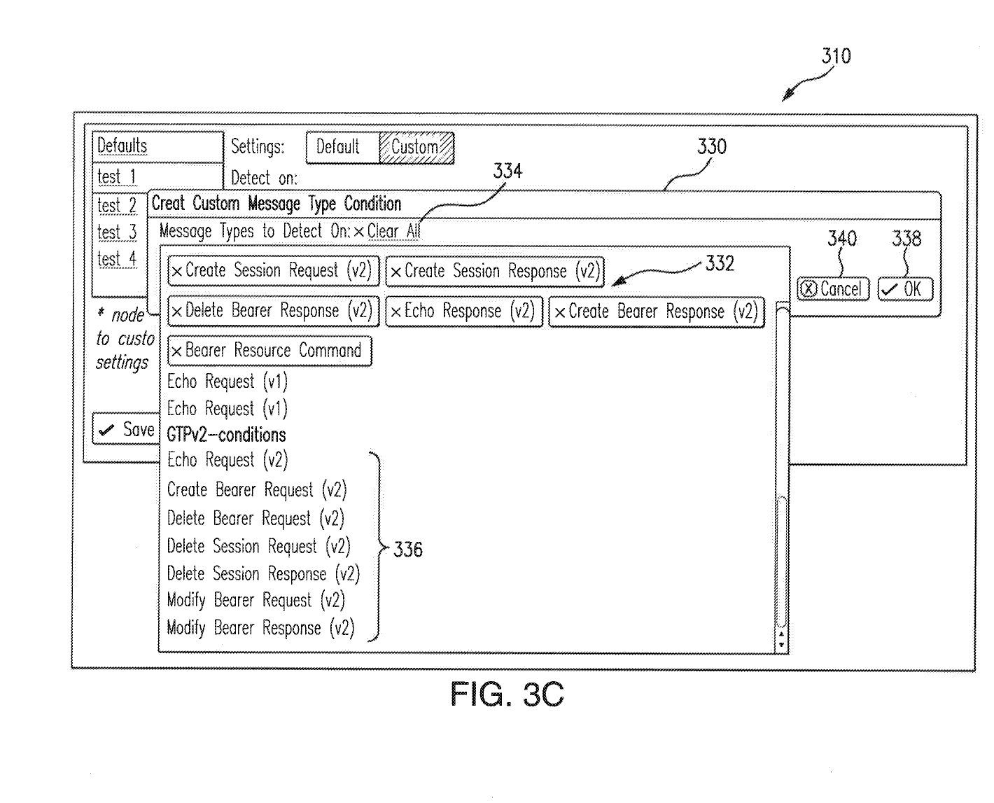

In response to determining that the user would like to set up one or more global alerts (step 204, yes branch), at 206, monitoring system 114 preferably presents to a user a global alerts configuration screen, via GUI 118. FIG. 3A illustrates an exemplary global alerts configuration screen 300 for generating network-wide GTP-C alert configuration data in accordance with an embodiment of the present invention. Global alerts configuration screen 300 may allow users to configure threshold values for one or more performance metrics and/or alert conditions they are interested in. In one simplified example, global alerts configuration screen 300 may include three network-wide performance metrics to select from: first message type volume 302a, second message type volume 302b and response time 302c. In the illustrated case, first message type volume 302a may include all messages using a control portion of the version 1 GPRS Tunneling Protocol (GTPv1-C), while the second message type volume 302b may include all messages using a control portion of a second version of a GPRS Tunneling Protocol (GTPv2-C). The third network performance metric 302c may be directed to GTP echo response messages. In one embodiment, configurable threshold values included in the global alerts configuration screen 300 may include minimum threshold value 304a and a maximum threshold value 304b for a given performance metric 302.

Referring again to FIG. 2, in response to determining that the user would like to set up one or more node-specific alerts (step 204, no branch), at 208, monitoring system 114 preferably presents to the user a node-specific alerts configuration screen, via GUI 118. FIG. 3B illustrates an exemplary global alerts configuration screen 310 for generating node-specific GTP-C alert configuration data in accordance with an embodiment of the present invention. Node-specific alerts configuration screen 310 may allow users to configure threshold values for one or more performance metrics and/or alert conditions they are interested in at a particular network node. In one embodiment, to customize alert settings for a particular node, the user may select a desired node name from a list contained within a frame 312, for example, as shown in FIG. 3B. In addition, the user may configure default settings, which may apply, for example, to all new nodes added to the network 100. In one embodiment, node-specific alerts configuration screen 310 may permit users to switch between default and custom settings by pressing corresponding “Default” 314a and “Custom” 314b buttons.

Still referring to FIG. 3B, the node-specific alerts configuration screen 310 may display a list of one or more network performance metrics 302 that may be monitored according to an embodiment of the present invention. Node-specific alerts configuration screen 310 may include a set of check boxes 316 associated with possible performance metrics 302. The user can select one or more check boxes 316 to designate which threshold values 304 will be configured and which alerts will be sent upon captured network traffic exceeding and/or falling below the specified threshold values 304. After the user has provided the threshold values 304 for the selected performance metrics 302 to monitor by checking the appropriate check boxes 316, the user may press “Save” button 318 under the frame 312 to save the inputted alert threshold settings and to exit the node-specific alerts configuration screen 310. It is noted that in this illustrative embodiment the list of one or more network performance metrics 302 that may be monitored may include message type volumes, response times and cause values. In GTP protocol cause values are typically used in response messages. Cause values may represent the actual status of the requested action (e.g., accept/reject) as well as additional useful information which would facilitate the receiving node to make a more informed decision on the possible course of action. A non-limiting list of possible cause values may include: “Request Accepted”, “Context not found”, “No resources available”, “No memory is available”, “User authentication failed”, “System failure”, “Invalid message format”, and the like.

According to an embodiment of the present invention, the node-specific alerts configuration screen 310 may also include a “New Condition” button 320. “New Condition” button 320 may be used to add one or more of new node-specific message type conditions to the customized alert settings. FIG. 3C illustrates an exemplary pop-up message window 330 for creating custom message type conditions in accordance with an embodiment of the present invention. In one embodiment, GUI 118 may display the pop-up message window 330 in response to a user pressing “New Condition” button 320 the node-specific alerts configuration screen 310. As shown in FIG. 3C, the user may select a plurality of message type conditions 332 from one or more lists of possible conditions, such as, for example, a list of GTPv2-Conditions 336. Pop-up message window 330 may include additional GUI controls, such as “Clear All” link 334, “OK” 338 and “Cancel” 340 buttons. For example, a user might clear all selected message types 332 using the “Clear All” link 334, the user may press “OK” button 338 to save the updated custom message type settings and to close pop-up message window 330. Lastly, “Cancel” button 340 may be provided to cancel the addition of new custom message type conditions to the alert configuration settings.

Referring back to FIG. 2, after displaying either the global alerts configuration screen 300 or node-specific alerts configuration screen 310 described above, at 210, monitoring system 114 preferably stores user entered alert settings in one or more databases of storage unit 120. As described above, in one embodiment the user-specified alert settings may be stored in response to user pressing “Save” button 318 shown in FIG. 3B.

At 212, monitoring system 114 may start to passively monitor at least a subset of the one or more network performance metrics related to control traffic configured via global alerts configuration screen 300 or node-specific alerts configuration screen 310 and stored in storage unit 120. According to an aspect of the invention, step 212 may include monitoring GTP-C network traffic through probes that are disposed between the various nodes in the network 100, such as SGSN 108 node and GGSN node 110, and may include communicating relevant control traffic data from the probes to monitoring system 114.

At 214, alert engine 116 of the monitoring system 114 preferably analyzes a relevant subset of the captured control traffic data to determine if any of the user-specified thresholds has been reached by the control traffic. For example, monitoring system 114 may determine whether the overall message volume corresponding to network-wide GTPv2-C types of messages has exceeded 200,000 mps threshold, which was setup by the user via global alerts configuration screen 300, for example. In response to determining that none of the thresholds have been reached (step 214, no branch), monitoring system 114 may continue collecting relevant control traffic data at step 212.

According to an embodiment of the present invention, in response to determining that at least one of the plurality of threshold values has been reached (step 214, yes branch), at 216, alert engine 116 preferably generates an alert notification message specifying a violated threshold value, for example. This step may further involve alert engine 116 sending the generated alert notification message. In various embodiments, the alert notification message can be transmitted with any kind of messaging system, implemented by any type of electronic communication device or system, including but not limited to, traditional email, instant messaging (or other web-based chat systems), SMS (Short Message Service), mobile phone or tablet applications, flags on social media/internet websites, microblogs, etc. Furthermore, the generated alert notification message may be a message that is displayed on a designated screen of GUI interface 118.

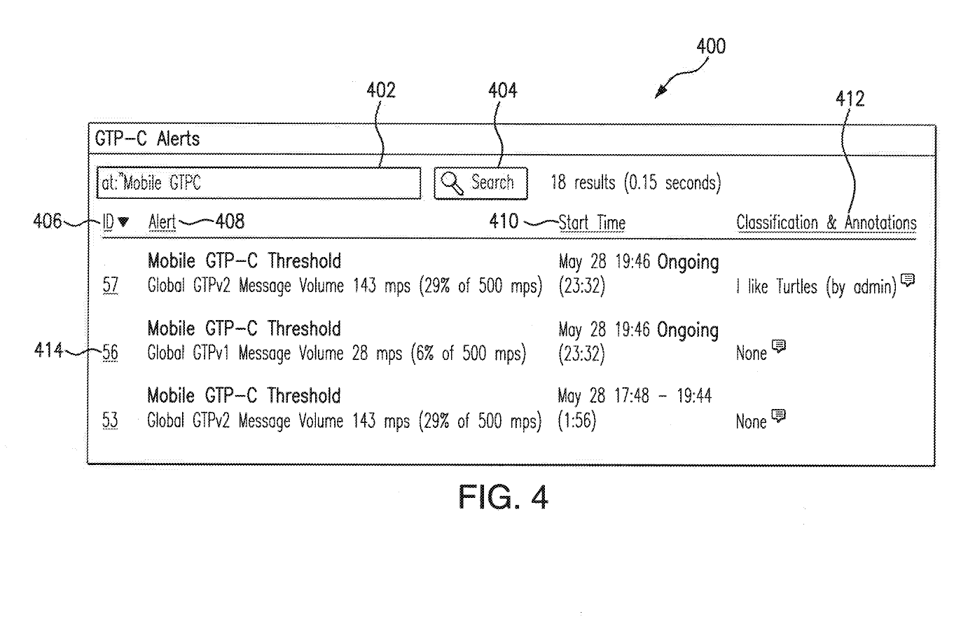

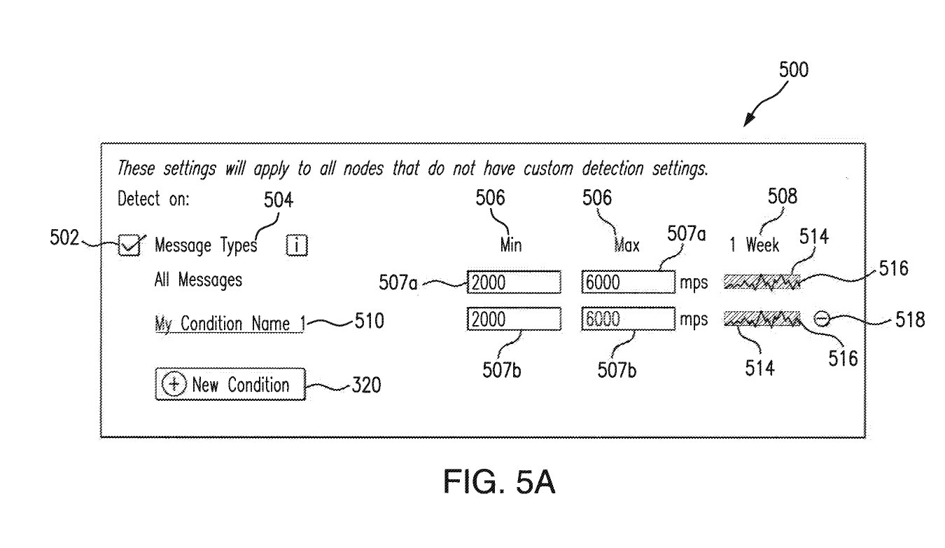

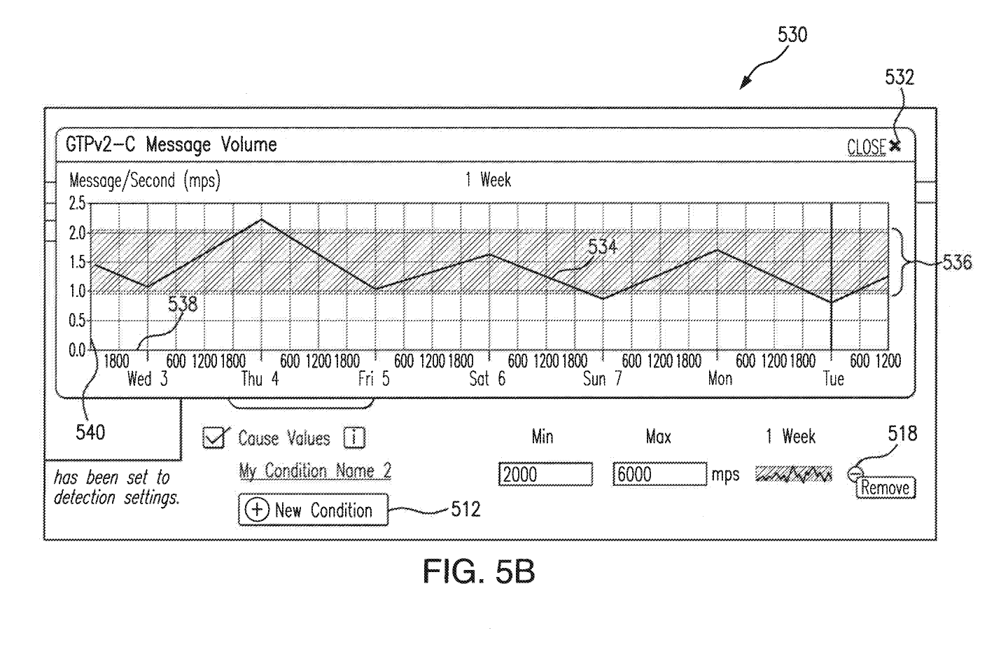

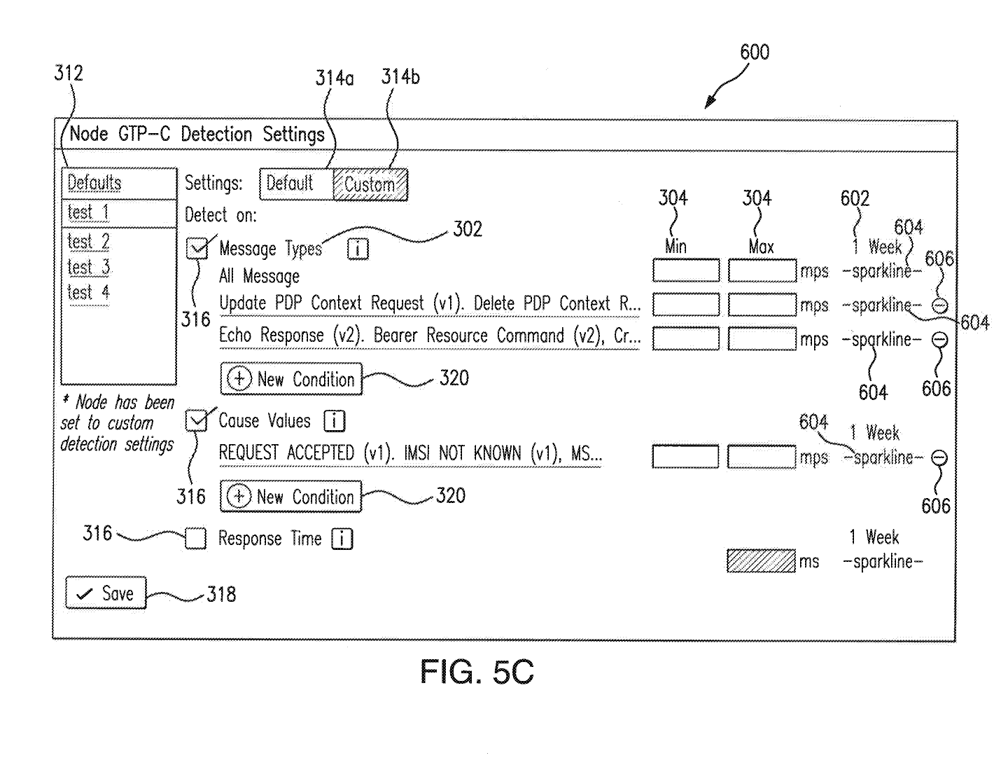

FIG. 4 is an exemplary screen 400 for presenting alert information according to an embodiment of the present invention. In one, embodiment, as shown in FIG. 4, a user may enter one or more search terms in text entry box 402, for example. In some embodiments, proximity and boolean operators may be used to narrow the scope of a search by typing them into the text entry box 402. A user may click a “Search” button 404 to perform a search. In response, GUI interface 118 of the monitoring system 114 may present search results as the list shown in FIG. 4. These search results may include, but are not limited to, alert ID 406, alert name/text 408, alert start time 410, and alert classification 412 fields. As shown in FIG. 4, the alert name/text field 408 may include text of a corresponding alert notification message as well as associated alert name (shown in a bold style). In one embodiment, the text of the alert notification message may specify information related to control traffic with respect to user-specified thresholds. Start time field 410 may provide information directed to corresponding alert's start time. The start time may be specified as a common time (e.g., May 28, at 19:46), as a relative time (e.g., each weekday at 11:30), or may be specified based on the occurrence of a particular condition (e.g., five minutes after the detection of a specified condition). It is contemplated that in some embodiments of the present invention, alert engine 116 of the monitoring system 114 may end the alert notification once monitored network performance metric falls back within the user-specified threshold range (i.e., between min and max threshold values). Accordingly, in some embodiments, start time field 410 of the alert screen 400 may indicate current status (e.g., “Ongoing”) of the corresponding alert notification message. The classification field 412 may include any user-specified classifications/annotations associated with the corresponding alert. Lastly, in one embodiment, GUI interface 118 may present alert IDs 406 as links to supplemental alert information. For example, in response to user clicking on a second link 414, GUI 118 may present a new page containing, for example, a line graph, related to the corresponding alert, as described below with reference to FIG. 5B.

FIGS. 5A-5C are schematic diagrams illustrating modified user interface screenshots of FIGS. 3A-3C utilizing sparklines and line graphs in accordance with an alternative embodiment of the present invention. The term “sparklines”, as used herein, refers to minimized diagrams that may be used to display a large amount of information in a compact and intelligible form. In other words, sparklines may be used to provide dense information in small spaces. In various embodiments described below, sparklines may be used to graphically represent trends in a particular network performance metric that changes over a predetermined period of time.

FIG. 5A illustrates an exemplary global alerts configuration screen 500 for generating network-wide GTP-C alert configuration data in accordance with an embodiment of the present invention that utilizes sparklines and line graphs. In this illustrative example, global alerts configuration screen 500 for generating network-wide GTP-C alert configuration data enables users to configure alerts for the “Message Types” control traffic category 504 by checking a corresponding check box 502. Further, in this case users may configure alert thresholds for two different network performance metrics: all control traffic messages and for control traffic that conforms to only a specific set of message types (i.e., “My Condition Name 1” 510). Users may have previously created this specific set of message types 510 by pressing on “New Condition” button 320.

According to an embodiment of the present invention, in order to present relevant control traffic trends, monitoring system 114 may analyze user-specified network performance metrics for a predetermined period of time. In this particular example, the predetermined period of time comprises one week 508. In other embodiments, the predetermined period of time 508 may comprise one hour, one day, and so forth. It should be noted that monitoring system 114 analyzes these user-specified performance metrics against corresponding ranges of threshold values 506. In other words, monitoring system 114 analyzes all messages captured in the past week and determines the range of values that would fall between the first set of user specified threshold values 507a (e.g., between the minimum value of 2000 mps and the maximum value of 6000 mps). Similarly, monitoring system 114 analyzes the control traffic captured in the past week that conforms to only a specific set of message types (i.e., “My Condition Name 1” 510) and determines the range of values that would fall between the second set of user specified threshold values 507b (e.g., between the minimum value of 2000 mps and the maximum value of 6000 mps). According to an embodiment of the present invention, based on the aforementioned analysis, GUI interface 118 of the monitoring system 114 may generate a pair of corresponding sparklines 514 and present them to a user via global alerts configuration screen 500, as shown in FIG. 5A. It is noted that each of the shaded regions 516 within each sparkline 514 corresponds to the ranges of values that would fall between corresponding sets of threshold values 507a and 507b, thus showing users respective amounts of relevant control traffic that would fall within user-specified ranges. Global alerts configuration screen 500 permits users to modify any of the corresponding sets of values 507a and 507b. According to an embodiment of the present invention, in response to such modification, monitoring system 114 preferably updates one or more of the sparklines 514 to reflect changes to the one or more of the alert threshold values 507a and 507b. In other words, global alerts configuration screen 500 advantageously enables users to explore potential threshold scenarios by setting the threshold values 507a and 507b and observing those threshold values reflected on the corresponding sparkline 514. In some embodiments, adjacent to one or more sparklines 514, global alerts configuration screen 500 may include a remove icon 518. Thus, by clicking the remove icon 518 shown in FIG. 5A, users may prevent the sparkline corresponding to the specific set of message types 510 from appearing on global alerts configuration screen 500.

According to one aspect of the present invention, if users are interested in viewing more detailed information related to the user-specified network performance metrics for the predetermined period of time, they may click on corresponding sparkline 514. In response, GUI interface 118 of the monitoring system 114 may display the granular performance metrics history for the predetermined period of time, as a line graph 534 shown in FIG. 5B. In one embodiment, GUI interface 118 may present line graph 534 though a designated pop-up window 530. The pop-up window 530 may include a control to remove the pop-up window from the display. In one embodiment, the pop-up window may include a close window icon 532. The close window icon 532 may show an “X” or other symbol indicating the pop-up window 530 will close if the icon 532 is selected. The close window icon 532 may be located in the upper right hand corner of the pop-up window 530. Selecting the close window icon 532 may result in the pop-up window 530 being removed from the display.

FIG. 5B illustrates an exemplary line graph 534 depicting the relationship of message volume and time for a predetermined time period according to an embodiment of the present invention. The X-axis 538 represents the time; the Y-axis 540 represents message volume. In one embodiment, where the predetermined time period comprises one week, the time is measured in hours, with one unit of time on the X-axis 538 being equal to 6 hours; the message volume is measured in messages/second (mps). In FIG. 5B, the solid line represents the relevant control traffic volume over time and the shaded region 536 represents the ranges of values that would fall between corresponding sets of threshold values 507a and 507b shown in FIG. 5A, thus showing users respective amounts of relevant control traffic that would fall within user-specified ranges. It is noted that the shaded region 536 represents a detailed depiction of the shaded region 516 within a corresponding sparkline 514. In one embodiment, advantageously, users may drag one or both boundaries of the shaded region 536 to dynamically reset threshold values 507a and 507b shown in FIG. 5A. In response, the shaded region 536 may either grow or shrink depending on users' actions. In addition, the Y-axis 540 representing message volume for the predetermined period may also change based on the users' adjustments to account for updated minimum and/or maximum values.

FIG. 5C illustrates an exemplary node-specific alerts configuration screen 600 for generating node-specific GTP-C alert configuration data in accordance with an alternative embodiment of the present invention. In this embodiment, in addition to elements 302-320 described above with reference to FIG. 3B, the node-specific alerts configuration screen 600 may include a plurality of sparklines 604 corresponding to each of the user-selected network performance metrics. It is noted that in this illustrative example the predetermined period 602 for which control traffic data is analyzed is also equal to one week. Further, by clicking the remove icon 606 shown in FIG. 5C, users may prevent the associated sparkline corresponding to the specific network performance metric from appearing on node-specific alerts configuration screen 600. Since sparkline generation functionality has been described above, the description will not be reiterated.

In summary, various embodiments of the present invention contemplate passive monitoring of the GTP-C (control) traffic across an entire mobile network and/or across any node within the mobile network, enabling the mobile network operator to understand the amount and type of mobile traffic that is passing through a specific node and/or through their mobile network. In one aspect, users may configure one or more alerts for each of the one or more network performance metrics (such as message types, cause values, response times) wherein each alert may include a set of threshold values (such as min and max). In another aspect, for each configured alert, monitoring system 114 may generate one or more graphs, such as sparklines and line graphs described above, to facilitate user's understanding of the trends of the control traffic over time, as well as how such traffic might cross potential thresholds.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of network monitoring system may be implemented or executed by centralized data management servers comprising one or more computer systems. One such monitoring server 115 is illustrated in FIG. 6. In various embodiments, monitoring server 115 may be a server, a mainframe computer system, a workstation, a network computer, a desktop computer, a laptop, or the like.

Monitoring server 115 is only one example of a suitable system and is not intended to suggest any limitation as to the scope of use or functionality of embodiments of the invention described herein. Regardless, monitoring server 115 is capable of being implemented and/or performing any of the functionality set forth hereinabove.

Monitoring server 115 may be described in the general context of computer system-executable instructions, such as program modules, being executed by a computer system. Generally, program modules may include routines, programs, objects, components, logic, data structures, and so on that perform particular tasks or implement particular abstract data types. Monitoring server 115 may be practiced in distributed data processing environments where tasks are performed by remote processing devices that are linked through a communications network. In a distributed data processing environment, program modules may be located in both local and remote computer system storage media including memory storage devices.

Monitoring server 115 is shown in FIG. 6 in the form of a general-purpose computing device. The components of monitoring server 115 may include, but are not limited to, one or more processors or processing units 616, a system memory 628, and a bus 618 that couples various system components including system memory 628 to processor 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Monitoring server 115 typically includes a variety of computer system readable media. Such media may be any available media that is accessible by monitoring server 115, and it includes both volatile and non-volatile media, removable and non-removable media.

System memory 628 can include computer system readable media in the form of volatile memory, such as random access memory (RAM) 630 and/or cache memory 632. Monitoring server 115 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions of embodiments of the invention.

Program/utility 640, having a set (at least one) of program modules 615, such as alert engine 116 and GUI interface 118, may be stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 615 generally carry out the functions and/or methodologies of embodiments of the invention as described herein.

Monitoring server 115 may also communicate with one or more external devices 614 such as a keyboard, a pointing device, a display 624, etc.; one or more devices that enable a user to interact with monitoring server 115; and/or any devices (e.g., network card, modem, etc.) that enable monitoring server 115 to communicate with one or more other computing devices. Such communication can occur via Input/Output (I/O) interfaces 622. Still yet, monitoring server 115 can communicate with one or more networks such as a local area network (LAN), a general wide area network (WAN), and/or a public network (e.g., the Internet) via network adapter 620. As depicted, network adapter 620 communicates with the other components of monitoring server 115 via bus 618. It should be understood that although not shown, other hardware and/or software components could be used in conjunction with monitoring server 115. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for monitoring control traffic in a network, the method comprising:
monitoring, by a network monitoring probe, one or more network performance metrics related to control traffic;
receiving from a user a plurality of threshold values associated with the one or more network performance metrics; and
sending an alert notification message to the user via an alert engine, in response to determining that at least one of the plurality of threshold values has been reached by the control traffic.

2. The method of claim 1, wherein the one or more network performance metrics include one or more of: a value indicative of an overall volume of control traffic, response time values, cause values.

3. The method of claim 1, wherein said step of monitoring comprises the network monitoring probe monitoring the one or more network performance metrics related to control traffic at a particular network node within the network.

4. The method of claim 3, wherein the particular network node comprises one of a Serving GPRS Support Node (SGSN) and a Gateway GPRS Support Node (GGSN).

5. The method of claim 1, further comprising analyzing the one or more network performance metrics for a predetermined period of time.

6. The method of claim 5, further comprising displaying to a user information related to the one or more network performance metrics for the predetermined period of time based on the analyzing step.

7. The method of claim 6, wherein the step of displaying further comprises generating a sparkline based on the analysis of the one or more network performance metrics for the predetermined period of time.

8. The method of claim 7, further comprising updating the sparkline in response to user's input associated with the plurality of threshold values.

9. The method of claim 7, further comprising displaying a line graph corresponding to the generated sparkline, in response to user's interaction with the generated sparkline.

10. The method of claim 9, further comprising updating the corresponding sparkline, in response to user's interaction with the line graph.

11. The method of claim 9, further comprising updating at least one of the plurality of threshold values, in response to user's interaction with the line graph.

12. The method of claim 5, further comprising analyzing one or more conditions associated with the one or more network performance metrics for the predetermined period of time.

13. A computer program product for monitoring control traffic in a network, the computer program product comprising:
one or more computer-readable storage devices and a plurality of program instructions stored on at least one of the one or more computer-readable storage devices, the plurality of program instructions comprising:
program instructions to monitor one or more network performance metrics related to control traffic;
program instructions to receive from a user a plurality of threshold values associated with the one or more network performance metrics; and
program instructions to send an alert notification message to the user, in response to determining that at least one of the plurality of threshold values has been reached by the control traffic.

14. The computer program product of claim 13, wherein the one or more network performance metrics include one or more of: a value indicative of an overall volume of control traffic, response time values, cause values.

15. The computer program product of claim 13, wherein said program instructions to monitor one or more network performance metrics related to control traffic comprise program instructions performed by a network monitoring probe monitoring the one or more network performance metrics related to control traffic at a particular network node within the network.

16. The computer program product of claim 15, wherein the particular network node comprises one of a Serving GPRS Support Node (SGSN) and a Gateway GPRS Support Node (GGSN).

17. The computer program product of claim 13, further comprising program instructions to analyze the one or more network performance metrics for a predetermined period of time.

18. The computer program product of claim 17, further comprising program instructions to generate a sparkline based on the analysis of the one or more network performance metrics for the predetermined period of time.

19. The computer program product of claim 18, further comprising program instructions to display a line graph corresponding to the generated sparkline, in response to user's interaction with the generated sparkline.

20. A computer system for monitoring control traffic in a network, the computer system comprising one or more processors, one or more computer-readable storage devices, and a plurality of program instructions stored on at least one of the one or more storage devices for execution by at least one of the one or more processors, the plurality of program instructions comprising:
program instructions to monitor one or more network performance metrics related to control traffic;
program instructions to receive from a user a plurality of threshold values associated with the one or more network performance metrics; and
program instructions to send an alert notification message to the user, in response to determining that at least one of the plurality of threshold values has been reached by the control traffic.
